(19) United States
(12) Patent Application Publication
(10) Pub. No.: US 2019/0372973 A1
(43) Pub. Date: Dec. 5, 2019

(54) DEVICE ONBOARDING WITH AUTOMATIC IPSK PROVISIONING IN WIRELESS NETWORKS

(71) Applicant: Cisco Technology, Inc., San Jose, CA (US)

(72) Inventors: Kedar Krishnanand Gaonkar, San Jose, CA (US); Jerome Henry, Pittsboro, NC (US); Rajesh S. Pazhyannur, Fremont, CA (US); Robert Edgar Barton, Richmond (CA)

(21) Appl. No.: 15/992,691

(22) Filed: May 30, 2018

(51) Int. Cl. H04L 29/06; H04W 12/06; H04W 12/04

(52) U.S. Cl. CPC H04L 63/0876; H04W 12/04; H04W 12/06; H04L 63/068

(57) ABSTRACT

In one embodiment, a device in a wireless network receives an association request sent by a node to associate with the network. The association request comprises a media access control (MAC) address of the node. The device obtains a serial number or manufacturer identifier of the node. The device establishes a secure connection between the node and the network using a temporal pre-shared key (PSK) based on the serial number or manufacturer identifier of the node. The device sends a second PSK to the node via the secure connection. The second PSK is unique in the network to the node and the node uses the second PSK for future communications with the network.

### TECHNICAL FIELD

The present disclosure relates generally to computer networks, and, more particularly, to device onboarding with automatic, individual pre-shared key (IPSK) provisioning in wireless networks.

### BACKGROUND

The Internet of Things, or “IoT” for short, represents an evolution of computer networks that seeks to connect many everyday objects to the Internet. Notably, there has been a recent proliferation of “smart” devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room, when a person enters the room.

IoT wireless clients are often headless devices with limited human interface capabilities. In most cases, their connection to wireless networks needs to be protected. As these constrained devices often do not support certificates or other individual authentication approaches, such as via the Extensible Authentication Protocol (EAP), username/password methods, etc., pre-shared key (PSK) approaches are a common choice for authentication and encryption. However, sharing a PSK among multiple devices is insecure and the key would need to be changed on all devices, when the PSK is compromised. Additionally, entering a PSK may be particularly difficult on simple IoT devices (e.g., a light bulb) that lack a proper human interface.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device/node;

FIG. 3 illustrates an example of individual pre-shared key (IPSK) usage in a wireless network;

FIGS. 4A-4F illustrate an example of provisioning a node in a wireless network; and

FIG. 5 illustrates an example simplified procedure for performing automatic IPSK provisioning in a wireless network.

### DESCRIPTION OF EXAMPLE EMBODIMENTS

### Overview

According to one or more embodiments of the disclosure, a device in a wireless network receives an association request sent by a node to associate with the network. The association request comprises a media access control (MAC) address of the node. The device obtains a serial number or manufacturer identifier of the node. The device establishes a secure connection between the node and the network using a temporal pre-shared key (PSK) based on the serial number or manufacturer identifier of the node. The device sends a second PSK to the node via the secure connection. The second PSK is unique in the network to the node and the node uses the second PSK for future communications with the network.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is. LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

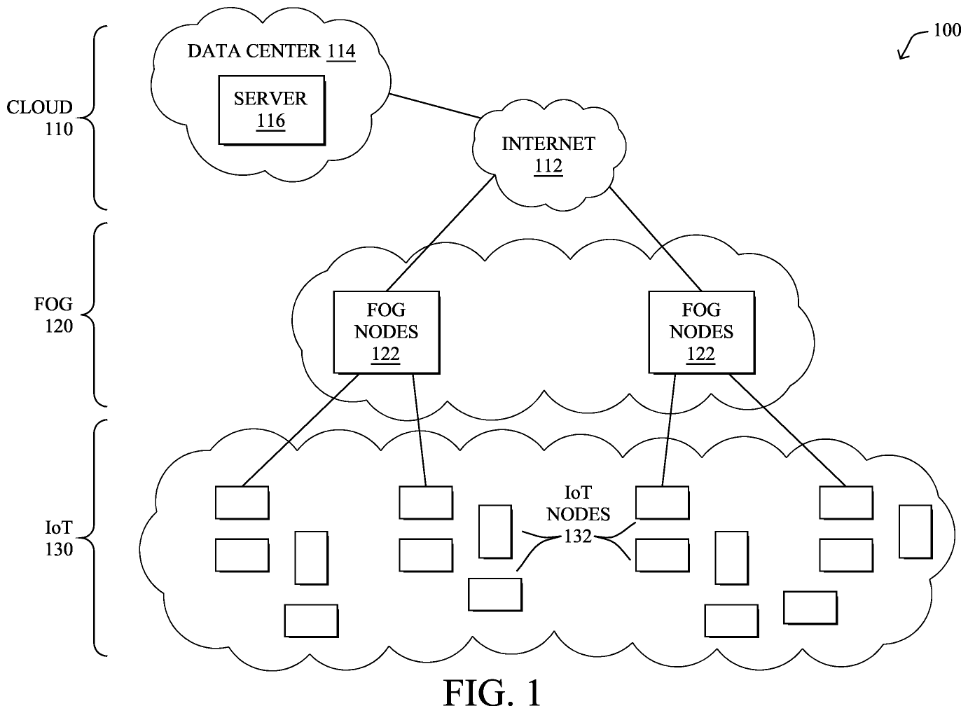

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely the cloud 110, fog 120, and IoT device 130. Illustratively, the cloud 110 may comprise general connectivity via the Internet 112, and may contain one or more datacenters 114 with one or more centralized servers 116 or other devices, as will be appreciated by those skilled in the art. Within the fog layer 120, various fog nodes/devices 122 may execute various fog computing resources on network edge devices, as opposed to datacenter/cloud-based servers or on the endpoint nodes 132 themselves of the IoT layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, a fog node 122 may operate as a root node for IoT nodes 132 in a local mesh, in some embodiments.

In contrast to traditional networks, LLNs face a number of communication challenges. First. LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or to humidity changes, etc.). The time scales of such temporal changes can range between milliseconds (e.g., transmissions from other transceivers) to months (e.g., seasonal changes of an outdoor environment). In addition. LLN devices typically use low-cost and low-power designs that limit the capabilities of their transceivers. In particular. LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

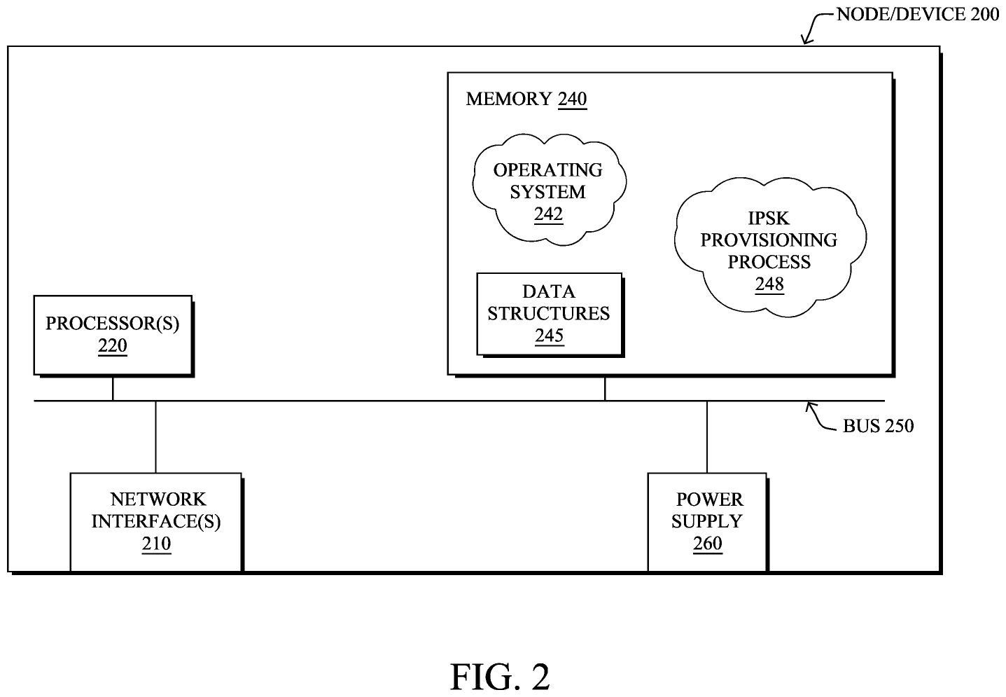

FIG. 2 is a schematic block diagram of an example computing device/node 200 that may be used with one or more embodiments described herein e.g., as any of the devices shown in FIG. 1 above or any of the devices described further below. The device may comprise one or more network interfaces 210 (e.g., wired, wireless, cellular, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network 100. The network interfaces may be configured to transmit and/or receive data using a variety of different communication protocols. Note, further, that the nodes may have two or more different types of network connections 210, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an illustrative individual pre-shared key (IPSK) process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

As noted above. PSK-based approaches are commonly used in wireless IoT networks over other approaches, since many IoT devices have constrained resources and do not support certificates or other individual authentication approaches. Typically, a PSK-based approach entails sharing a PSK among multiple devices. Doing so, however, is insecure. In addition, when a PSK is compromised, the key would need to be changed on each device, which can prove difficult, as many IoT devices (e.g., light bulbs, etc.) also lack proper human interfaces.

Device Onboarding with Automatic IPSK Provisioning in Wireless Networks

The techniques herein introduce a network onboarding mechanism that utilizes individual PSKs (IPSKs), thereby allowing each client node joining the network to use its own PSK instead of a shared PSK. In some aspects, the techniques herein allow for the use of a temporal key on an IoT client node as a seed to create a secured communication with a network access point, over which the IPSK can be seeded to the client. Such a temporal key may be learned by the wireless network infrastructure during the client validity verification phase of the onboarding process and may be based on a serial number or other manufacturer identifier associated with the client. For example, the temporal key may be fed along with the client validation data, in some cases.

Specifically, according to one or more embodiments of the disclosure as described in detail below, a device in a wireless network receives an association request sent by a node to associate with the network. The association request comprises a media access control (MAC) address of the node. The device obtains a serial number or manufacturer identifier of the node. The device establishes a secure connection between the node and the network using a temporal pre-shared key (PSK) based on the serial number or manufacturer identifier of the node. The device sends a second PSK to the node via the secure connection. The second PSK is unique in the network to the node and the node uses the second PSK for future communications with the network.

Illustratively, the techniques described herein may be performed by hardware, software, and/or firmware, such as in accordance with IPSK provisioning process 248, which may include computer executable instructions executed by the processor 220 (or independent processor of interfaces 210) to perform functions relating to the techniques described herein.

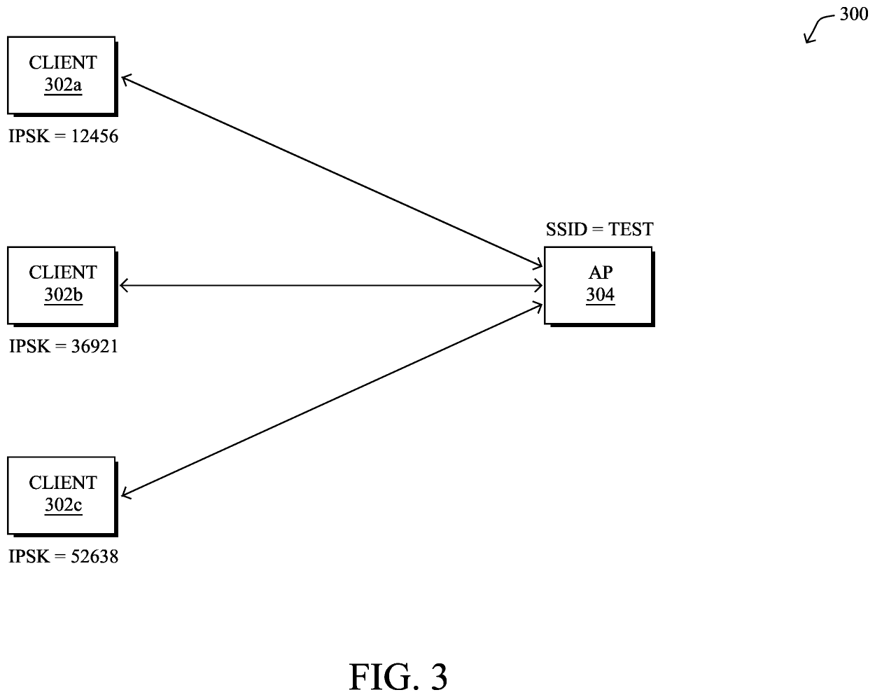

Operationally, the techniques herein employ the concept of individual PSKs (IPSKs), meaning that each client node in the network receives and uses its own individual PSK. FIG. 3 illustrates an example of IPSK usage in a wireless network. As shown, assume that network 300 includes client nodes 302a-302c that attach to network 300 via a wireless access point (AP) 304. AP 304 may broadcast its SSID, “Test.” to each of client nodes 302a-302c, to identify network 300 to these nodes. Using a traditional PSK-based mechanism, each of client nodes 302a-302c would use the same PSK, to join network 300 via AP 304. For example, client node 302a may use a PSK=“Foo 123,” client node 302b may also use PSK=“Foo 123,” and client node 302c may also use PSK=“Foo123.”

In contrast to traditional PSK, an IPSK-based approach mandates that each client use an individual PSK, which may be uniquely used by a given client in the network, in various embodiments. For example, as shown, client node 302a may use an IPSK=“12456,” while client node 302b may use an IPSK=“36921.” and client node 302c may use an IPSK=“52638.” In other words, in an IPSK-based approach, each client connecting to a certain SSID can potentially have a different key, which is more secure than traditional PSK-based approaches.

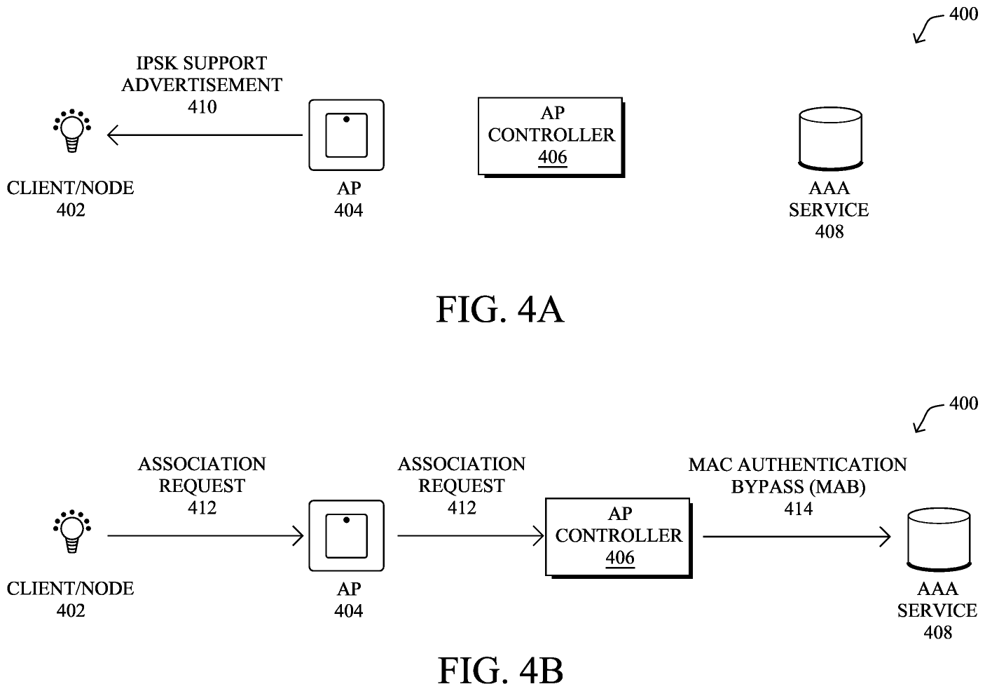

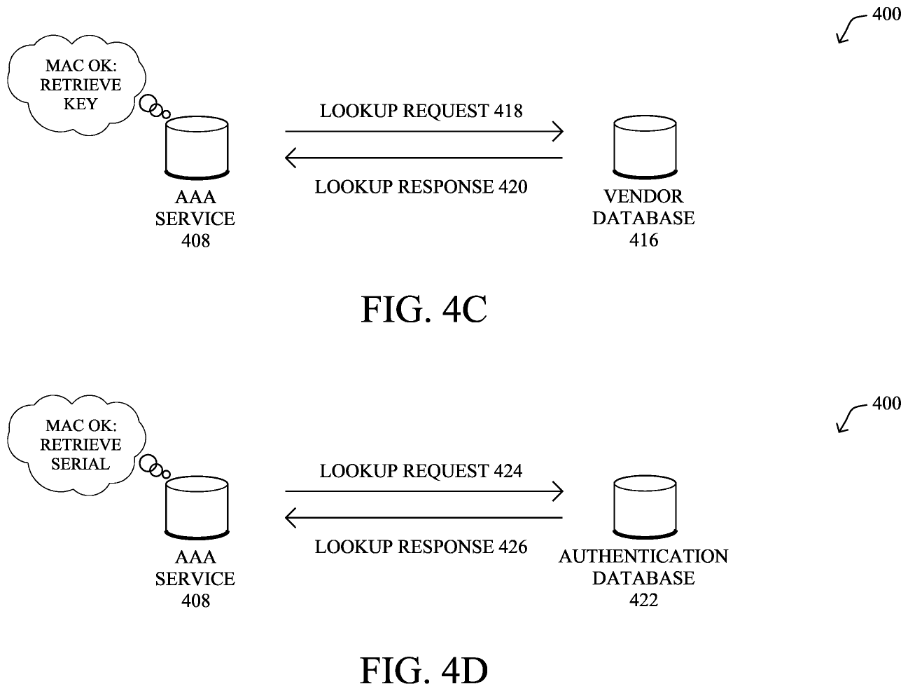

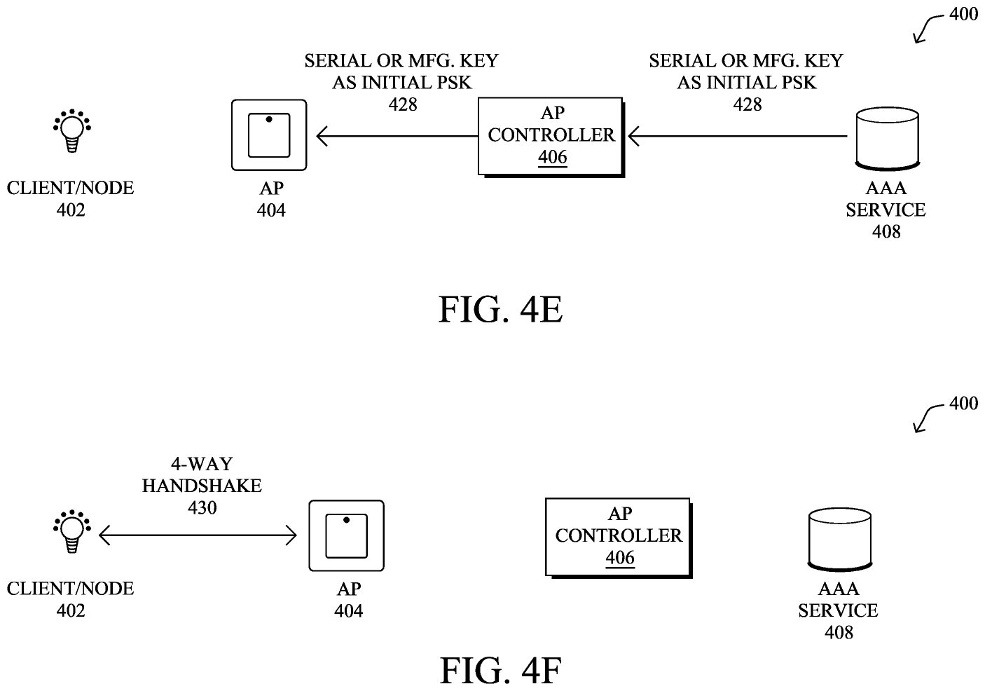

FIGS. 4A-4F illustrate an example of provisioning a node in a wireless network, in accordance with the teachings herein. As shown in FIG. 4A, assume that a network 400 includes an access point (AP) 404, an AP controller 406, such as a wireless LAN controller (WLC) or other device that controls AP 404, and an Authentication. Authorization. and Accounting (AAA) service 408 in communication therewith. Also, assume that there is a client/node 402 that is to be onboarded to network 400 via AP 404. For example, client/node 402 may be a smart lightbulb or other IoT device that allows client/node 402 to report data (e.g., sensor readings) and/or receive control commands (e.g., actuation commands) via network 400.

To begin the onboarding process for client/node 402. AP 404 may broadcast an IPSK support advertisement 410 that indicates to client/node 402 that AP 404 supports dynamic IPSK provisioning. In one embodiment, this can be achieved by AP 404 adding a custom information element (e.g., an 802.11u element or the like) to the AP beacons and probe responses used for network discovery. Such dynamic IPSK provisioning support can be temporal or permanent, in various embodiments. For example, a network administrator can specify to AP controller 406 whether dynamic IPSK provisioning is enabled in network 400 at any given time, thereby allowing the administrator to enable dynamic IPSK provisioning only in times of device onboarding, when the IPSKs in use need to be rotated, or otherwise as desired.

Next, client/node 402 discovers network 400 (e.g., via the probe requests). In response to detecting AP 404 broadcasting IPSK support advertisement 410, client/node 402 may attempt to associate with network 400 via AP 404. This may entail client/node 402 sending an 802.11 authentication request to AP 404, to which AP 404 response to client/node 402 with an 802.11 authentication response. In other words, client/node 402 and AP 404 may use a standard authentication phase (and do not use WEP, which has become obsolete).

Once authenticated, as shown in FIG. 4B, client/node 402 may send an association request 412 to AP 404, which forwards request 412 on to AP controller 406. In turn. AP controller 406 may send request 412 on to AAA service 408 using the Extensible Authentication Protocol (EAP) or the like. For example, as shown, AAA service 408 may convert association request 412 into a media access control (MAC) authentication bypass (MAB) request 414. As would be appreciated, association request 412 may include certain information about client/node 402, such as the MAC address of client/node 402 and/or other information that can be used by network 400 to complete the association process.

In response to receiving the MAC address of client/node 402. AAA service 408 may check to ensure that the MAC address is valid. For example, AAA service 408 may maintain a list of valid MAC addresses. Alternatively, AAA service 408 may retrieve such a list from an authentication database, such as authentication database 422 depicted in FIG. 4D.

According to various embodiments, in addition to the MAC address of client/node 402. AAA service 408 may also maintain the serial number or a manufacturer identifier for client/node 402. For example, during manufacturing, the manufacturer of client/node 402 may enter a key value into client/node 402 (which can differ from the serial number), such as a model number or other value that may be either unique to each individual bulb or common to an identifiable set of bulbs. In various embodiments, a temporal key can be used to establish a secure connection between client/node 402 and AP 404 that is based in part on the serial number or manufacturer identifier of client/node 402. As would be appreciated, use of a temporal key in a wireless network is typically limited in nature, such as to encrypt data for only the current session.

In some embodiments, as shown in FIG. 4C, AAA service 408 may send a lookup request 418 to a vendor database 418 associated with client/node 402 over a secure connection, either prior to association of client/node 402 with network 400 or during the association phase. For example, request 418 may include the MAC address of client/node 402 and request the key value set by the manufacturer on client/node 402 during manufacture or, alternatively, the serial number of client/node 402. To a certain extent, such a query may be somewhat akin to a Manufacturer User Description (MUD) query, as described in the Internet Engineering Task Force (IETF) draft entitled “Manufacturer User Description Specification.” However, with the query mechanism proposed herein, the infrastructure of network 400 initiates the query, instead of client/node 402. In response to receiving lookup request 418, vendor database 416 may return a lookup response 420 to AAA service 408 that includes either the manufacturer identifier or serial number of client/node 402.

Alternatively, in further embodiments, AAA service 408 may perform a lookup of the serial number or manufacturer identifier from authentication database 422, as shown in FIG. 4D. For example, AAA service 408 may send lookup request 424 to authentication database 422 that includes the MAC address of client/node 402. In response, authentication database 422 may send a lookup response to AAA service 408 that includes the requested serial number or other manufacturer identifier of client/node 402.

Regardless of where AAA service 408 obtains the serial number or manufacturer identifier of client/node 402. AAA service 408 may send a message 428 back to AP controller 406 that includes the serial number or manufacturer identifier. In one embodiment. AAA service 408 may also include the IPSK to be used with client/node 402 in message 428. In turn, AP controller 408 may send the information of message 428 on to AP 404.

According to various embodiments. AP 404 may use a temporal/initial PSK based on the serial number or manufacturer identifier of client/node 402, to establish a secure connection with client/node 402. For example, on receipt of message 428, AP 404 may return an association success message to client/node 402. In turn, as shown in FIG. 4F, AP 404 may perform a (4-way) handshake 430 with client/node, using the temporal/initial PSK as the PSK for handshake 430. In the last frame of handshake 430, AP 430 may then unicast the group key to client/node 402. In addition, in some embodiments. AP 404 may use the temporal secure connection created via handshake 430, to unicast the IPSK generated by AAA service 408 to client/node 402.

Said differently. AP 404 and client/node 402 may establish a secure connection using a temporal key based on the serial number or manufacturer identifier of client/node 402. In some embodiments, the temporal key may be equal to the serial number or manufacturer identifier, or derived therefrom. In another embodiment, the temporal key may be a function of the MAC address of client/node 402, as well as the serial number or manufacturer identifier of client/node 402. Using this secure connection, which is temporary in nature. AP 404 can send the IPSK computed by the infrastructure of network 400 to client/node 402.

As a result of the above steps, client/node 402 now has an IPSK that is unique to it in network 400 and provisioned dynamically by network 400 over a temporal and secure connection. In turn, AP 404 may stop advertising its dynamic IPSK support in its beacons and/or probe responses, and client/node 402 may use its received IPSK for further communications with AP 404.

At configurable, periodic, or random intervals, AP 404 may resume advertising its dynamic IPSK support to client/node 402, using a variation of its initial advertisement 410 (e.g., a gratuitous unicast probe response with a variation of the dynamic IPSK bits), to indicate that the IPSK currently used by client/node 402 needs to be changed. In turn, client/node 402 may use its current IPSK to maintain a secure connection with AP 402, thereby allowing AAA service 408 to compute and send a new IPSK to client/node 402 via that secure connection.

In another embodiment, provisioning of client/node 402 may be achieved through an application and can even be performed offsite of network 400. For example, an administrator may use a provisioning application to form a secure connection with the infrastructure of network 400. Using this connection, the application may send the serial number or other manufacturer identifier of client/node 402 to AAA service 408, authentication database 422, or any other device in network 400. In various embodiments, the application may retrieve the serial number or other manufacturer identifier by scanning a QR code or barcode on the exterior of client/node 402, via a near field communication (NFC) link with client/node 402, or the like.

Once the key is sent to the application, the device running the application may disconnect assume the temporal role of the provisioning AP 404, in further embodiments. The process is the same as detailed above, but allows for the provisioning of client/node 402, before network 400 is deployed (priming) or in a location that is different from the target network 400. In turn, client/node 402 can be sent to its intended location and associate with network 400 using its provisioned IPSK.

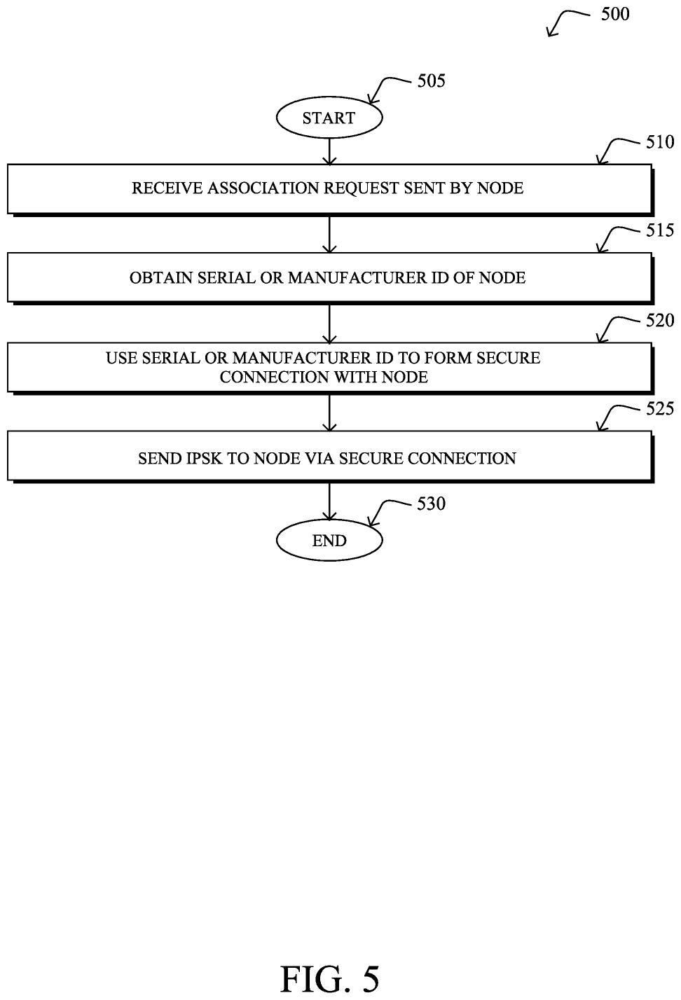

FIG. 5 illustrates an example simplified procedure for performing automatic IPSK provisioning in a wireless network, in accordance with one or more embodiments described herein. For example, a non-generic, specifically configured device (e.g., device 200), such as an AP, AP controller, or other infrastructure device of the network, may perform procedure 500 by executing stored instructions (e.g., process 248). The procedure 500 may start at step 505, and continues to step 510, where, as described in greater detail above, the device may receive an association request sent by a node to associate with the network. In various embodiments, the association request comprises a media access control (MAC) address of the node.

At step 515, as detailed above, the device may obtain a serial number or manufacturer identifier of the node. In some embodiments, the device may obtain a serial number of the node from an authentication database (e.g., via an AAA service), using the MAC address of the node. In further embodiments, the device may obtain a manufacturer identifier for the node from a database associated with a manufacturer of the node (e.g., via an AAA service), using the MAC address of the node. In other embodiments, the device may obtain the serial number or manufacturer identifier of the node through a reading of an external code on the node or via an NFC connection between an onboarding application and the node.

At step 520, the device may establish a secure connection between the node and the network using a temporal pre-shared key (PSK), as described in greater detail above. In various embodiments, the temporal PSK may be based on the serial number or manufacturer identifier of the node. For example, the temporal PSK may be the serial number or manufacturer identifier itself, may be derived therefrom, or may be a function of both the MAC address and serial number or manufacturer identifier of the node.

At step 525, as detailed above, the device may send a second PSK to the node via the secure connection. In various embodiments, the second PSK may be unique in the network to the node (e.g., is not shared between the node and other clients of the network) and the node uses the second PSK for future communications with the network. Said differently, the device may send an IPSK to the node via the secure tunnel created using the temporal PSK in step 520. In turn, the node may use the IPSK to secure further communications between the node and the network. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce an onboarding mechanism for wireless networks that employ a temporal key based on the serial number or manufacturer identifier of a joining client, to form a secure connection between the client and the network. In turn, a PSK that that is unique to the client can be sent to the client via the connection secured using the temporal key. The client can then use this new PSK for further communications with the network. Consequently. PSKs are not shared with other clients of the network, making the wireless network more secure and easier to manage.

While there have been shown and described illustrative embodiments that provide for device onboarding with automatic IPSK provisioning in a wireless network, it is to be understood that various other adaptations and modifications may be made within the spirit and scope of the embodiments herein. For example, while certain embodiments are described herein with respect to using certain protocols, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method, comprising:
receiving, at a device in a wireless network, an association request sent by a node to associate with the network, wherein the association request comprises a media access control (MAC) address of the node;
obtaining, by the device, a serial number or manufacturer identifier of the node;
establishing, by the device, a secure connection between the node and the network using a temporal pre-shared key (PSK) based on the serial number or manufacturer identifier of the node; and
sending, by the device and over the secure connection that is established using the temporary PSK, a second PSK to the node, wherein the second PSK is unique in the network to the node and the node uses the second PSK to establish at least one connection for future communications with the network.

2. The method as in claim 1, wherein the device obtains a serial number of the node from an authentication database, using the MAC address of the node.

3. The method as in claim 1, wherein the device obtains a manufacturer identifier for the node from a database associated with a manufacturer of the node, using the MAC address of the node.

4. The method as in claim 1, wherein establishing the secure connection between the node and the network comprises:
performing a handshake between the network and the node using the temporal PSK.

5. The method as in claim 1, wherein the temporal PSK is computed as a function of the MAC address of the node and as a function of the serial number or manufacturer identifier of the node.

6. The method as in claim 1, wherein the device obtains the serial number or manufacturer identifier of the node via an external code on the node.

7. The method as in claim 1, wherein the device comprises a wireless access point, and wherein the method further comprises:
broadcasting, by the access point, support for individual PSK provisioning, wherein the access point receives the association request from the node in response to the broadcast.

8. The method as in claim 7, further comprising:
stopping, by the access point, the broadcast support after sending the second PSK to the node.

9. The method as in claim 1, wherein the device receives the second PSK from an Authentication, Authorization, and Accounting (AAA) service in the network.

10. An apparatus, comprising:
one or more network interfaces to communicate with a network;
a processor coupled to the network interfaces and configured to execute one or more processes; and
a memory configured to store a process executable by the processor, the process when executed configured to:
receive an association request sent by a node to associate with the network, wherein the association request comprises a media access control (MAC) address of the node;
obtain a serial number or manufacturer identifier of the node;
establish a secure connection between the node and the network using a temporal pre-shared key (PSK) based on the serial number or manufacturer identifier of the node; and
send, over the secure connection that is established using the temporary PSK, a second PSK to the node, wherein the second PSK is unique in the network to the node and the node uses the second PSK to establish at least one connection for future communications with the network.

11. The apparatus as in claim 10, wherein the apparatus obtains a serial number of the node from an authentication database, using the MAC address of the node.

12. The apparatus as in claim 10, wherein the apparatus obtains a manufacturer identifier for the node from a database associated with a manufacturer of the node, using the MAC address of the node.

13. The apparatus as in claim 10, wherein the apparatus establishes the secure connection between the node and the network by:
performing a handshake between the network and the node using the temporal PSK.

14. The apparatus as in claim 10, wherein the temporal PSK is computed as a function of the MAC address of the node and as a function of the serial number or manufacturer identifier of the node.

15. The apparatus as in claim 10, wherein the device obtains the serial number or manufacturer identifier of the node via an external code on the node.

16. The apparatus as in claim 10, wherein the apparatus comprises a wireless access point, and wherein the process when executed is further configured to:
broadcast support for individual PSK provisioning, wherein the access point receives the association request from the node in response to the broadcast.

17. The apparatus as in claim 16, wherein the process when executed is further configured to:
stop the broadcast support after sending the second PSK to the node.

18. The apparatus as in claim 10, wherein the apparatus receives the second PSK from an Authentication, Authorization, and Accounting (AAA) service in the network.

19. A tangible, non-transitory, computer-readable medium storing program instructions that cause a device in a network to execute a process comprising:
receiving, at the device, an association request sent by a node to associate with the network, wherein the association request comprises a media access control (MAC) address of the node;
obtaining, by the device, a serial number or manufacturer identifier of the node;
establishing, by the device, a secure connection between the node and the network using a temporal pre-shared key (PSK) based on the serial number or manufacturer identifier of the node; and
sending, by the device and over the secure connection that is established using the temporary PSK, a second PSK to the node, wherein the second PSK is unique in the network to the node and the node uses the second PSK to establish at least one connection for future communications with the network.

20. The computer-readable medium as in claim 19, wherein the temporal PSK is computed as a function of the MAC address of the node and as a function of the serial number or manufacturer identifier of the node.
